(19) United States
(12) Patent Application Publication
(10) Pub. No.: US 2015/0373449 A1
(43) Pub. Date: Dec. 24, 2015

(54) ILLUMINATED AUDIO CABLE

(71) Applicant: Matthew D. Jackson, Bellevue, WA (US)

(72) Inventor: Matthew D. Jackson, Bellevue, WA (US)

(21) Appl. No.: 14/313,891

(22) Filed: Jun. 24, 2014

(51) Int. Cl. H04R 1/10; F21V 8/00; F21V 33/00; H01B 11/18

(52) U.S. Cl. CPC H04R 1/1033; H01B 11/18; G02B 6/001; F21V 33/0056

(57) ABSTRACT

Aspects of an illuminated audio cable are disclosed, including combinations of various audio signal conduits and various light emitting cables, wires and strips, configurations for attaching audio signal conduit to light emitting cables, wires and strips, functionality and physical locations of driver electronics for various light emitting cables, wires and strips, and physical locations for driver controllers. Optical fiber solutions that allow side emitting optical fibers to act as both an illumination device and a signal or data conduit are also disclosed. Applications of illuminated audio cables are also disclosed, including various styles of headphones, personal home audio equipment, and live music performance. Additional applications unrelated to audio cables are also disclosed.

### TECHNICAL FIELD

This disclosure relates to communications cabling and decorated audio wiring in particular. This disclosure also relates to illuminated cabling.

### BACKGROUND

Audio cabling delivers an audio signal from an input source to an output destination over a typical physically flexible connection. Construction may be of many materials, but usually includes one or more electrically conductive wires, often stranded wires, inside an electrically insulating layer. Common applications of audio cabling include transporting an audio signal to speakers from an audio source, such as a personal music player device, cell phone, radio, or consumer music amplifier and source switcher. Speakers can be often free-standing and fill a room with the audio signal, but can also be personal speakers, called headphones or earphones, where a speaker is positioned near a single listener's ear, typically with a stereo signal driving two speakers, one speaker for each of a listener's ears. The headphone speakers may be circumaural with pads that press against a listener's head and surround the listener's ears, superaural with pads that press directly against the ears, or earbuds that fit into the listener's ears. A headphone system may have only one speaker for a single ear or may have two speakers for both ears. A headset is a headphone system combined with a microphone, where the audio cabling has both an input and output at one end.

Connectors at the end of an audio cable facilitate connection of the cable to a source or destination, and these connectors come in many forms. In the case of headphones, the speakers are typically permanently connected, or hard-wired, to the audio cabling. In the case of stand-alone consumer room speakers, the bare wire conductor from the audio cabling, with the insulation layer removed, is soldered, screwed, or otherwise attached to an electrical contact on the speaker. In other cases, a standardized connector or plug is more typical. RCA connectors (with a name derived historically from the Radio Corporation of America) are often used on audio cabling interconnects between various types of consumer electronic equipment, such as between a CD player and a music amplifier and source switcher. The connector (or plug or jack) at the end of a pair of headphones is typically a “mini” 3.5 mm (millimeter) diameter plug with three contacts called the “TRS”, which stands for contacts at the tip, ring, and sleeve. “Sub-mini” 2.5 mm connectors and older, larger, regular ¼ inch (6.35 mm) plugs are also used for headphones, and there are also two-contact TS (tip and sleeve) plug and four contact TRRS (tip, ring, ring, and sleeve) plug variations. Most headphones for personal music players today have a 3.5 mm TRS plug or jack, and cellphone headsets with a microphone have a 3.5 mm TRRS jack.

Audio cabling can include digital as well as analog audio signals, and the signals can be electrical or optical. Optical signals are typically transmitted over fiber optic cabling. Digital signaling can be done over both electrical and optical cabling. Some electrical digital signaling formats includes S/PDIF (Sony/Philips digital interface format) over coaxial cable with RCA connectors, AES/EBU (Audio Engineering Society/European Broadcast Union, also known as AES3) with XLR connectors (defined, for example, in the International Electrotechnical Commission standard IEC 61076-2-103), and even Ethernet signaling and cabling is used for professional digital audio mixing consoles. Some optical signaling formats over fiber optic cable include S/PDIF with TOSLINK connectors, the ADAT (Alesis Digital Audio Tape) Lightpipe protocol, and TDIF (Tascam Digital Interconnect Format) with a DB25 (25-pin D-subminiture) plug.

Electroluminescent wire (EL wire) uses an alternating current with phosphor to create a light-emitting cable. It consists typically, from core to outer layers, of a copper wire core, covered by a coating of phosphor, a very fine second copper wire spiraling around the phosphor, and a translucent protective sleeve. An alternating current with a high voltage of perhaps 90 to 120 volts at about 1000 Hz applied between the copper core and the fine second copper wire can excite the phosphor, causing it to emit light. The color of light produced by phosphor in this way is limited, so a colored translucent outer sleeve is sometimes used to produce a wider variety of colors.

### SUMMARY

An illuminated audio cable is disclosed comprising one or more audio signal conduits for one or more audio channels, and comprising at least one strip of light emitting material connected to the signal conduit along the length of the signal conduit. Embodiments include an illuminated audio cable wherein: an audio output from the signal conduit is connected to headphones; an audio input to the signal conduit is configured to enable connection to a musical instrument; or the strip of light emitting material is one of: electroluminescent wire, electroluminescent tape, side glow fiber optic strands, and a string of LEDs (light emitting diodes). Embodiments further include an illuminated audio cable wherein: the at least one strip of light emitting material is electroluminescent tape with a first edge and a second edge, wherein the first edge is along the length of the tape and the second edge along the length of the tape and opposite the first edge; the audio signal conduit comprises a first wire and a second wire; the first wire is connected to the first edge; and the second wire is connected to the second edge.

Additional embodiments include aspects of the driver for the strip of light emitting material in an illuminated audio cable, such as: wherein the location of driver electronics for the strip of light emitting material is located at least in one of: integrated into the audio source, integrated into the audio destination, integrated into the cable itself, or integrated into plug at an end of the cable. Further driver aspects disclosed include driver electronics that are connected to at least one control, the control is physically separate from the driver, and the location of the control one of: integrated into the audio source, integrated into the audio destination, integrated into the cable itself, or integrated into plug at an end of the cable.

### BRIEF DESCRIPTION OF THE DRAWINGS

FIG. 1 is an illustration of an EL wire side-by-side with audio.

FIG. 2 is an illustration of EL tape between two audio wires.

FIG. 3 is an illustration of EL wire between audio wires.

FIG. 4 is an illustration of fiber optic cable combined with an audio cable.

FIG. 5 is an illustration of an LED chain cable combined with multiple audio cables.

FIG. 6 is an illustration of audio wiring inserted into a light strip cable.

FIG. 7 is an illustration of an EL tape wrapped audio cable pair.

FIG. 8 is an illustration of audio inserted in a bundle of multiple lighted core elements.

FIG. 9 is an illustration of some applications for illuminated audio cabling.

FIG. 10 is an illustration of earbud headphones with illuminated audio cabling and a cable mounted driver.

FIG. 11 is an illustration of a driver incorporated into the handle of an audio plug.

FIG. 12 is an illustration of an illuminated audio cable application in live music performance.

FIG. 13 is an illustration of a standard home stereo system with illuminated audio cable.

FIG. 14 is an illustration of a circumaural headphone with the driver integrated into the head mounted components.

FIG. 15 is an illustration depicting the components of a driver for an illuminated audio cable.

FIG. 16 is an illustration depicting components of a cable containing an electroluminescent wire.

### DETAILED DESCRIPTION OF ILLUSTRATIVE EMBODIMENTS

This disclosure presents a variety of designs for illuminated audio cabling in a broad range of applications. Most electrical and communications wiring is black in exterior color. Personal audio headphones, however, have a history of brighter colors. Currently popular are the white earbuds with white cabling that accompany many of APPLE personal electronics products. Several years ago, yellow cabling on earbuds for certain SONY products were popular. Unlike most wiring applications, where wiring is best hidden from a casual observer, earbud wiring has become both a fashion accessory and marketing tool. White earbuds, for example, may be strongly associated with Apple's products, just as yellow earbud wiring used to be associated with Sony's sports oriented Walkman products. Cellphone headsets and headphones for personal audio players are available with cabling in a wide variety of bright exterior colors. For example, SKULLCANDY sells a wide range of earphones and earbuds in a variety of colors, from royal blue to hot pink, with matching or color coordinated cabling. Audio enthusiasts may use the bright colors, worn over their clothing, as statement of personal taste, and audio product manufacturers may use the bright colors as a branding tool. Whatever the motivation, it is clear that there is market demand for wiring that can provide a novelty factor or visual appeal. Illuminated audio cabling may provide such novelty and visual appeal.

Audio cabling can be self-illuminated by combining any audio cabling technologies with a flexible linear illumination source. A non-limiting example is an electroluminescent wire (referred to herein as EL wire) fused or glued to an otherwise ordinary “Y” shaped earbud audio wire. Separate EL wires can start at the speaker for each ear and merge into a single EL wire at the “Y” intersection in the audio signal wire, continuing as a single EL wire down to the plug for a personal music player or smart phone. The glow from the EL wire, especially at night or in a darker setting, will make the wearer stand out due to the brightly colored illumination. EL wire generally requires an electric power source and driver electronics, which may, for example, be incorporated into a personal audio player that also provides the source audio signal for earbuds. Any switches or controls for the lighting of the EL wire may be incorporated into the personal audio player physically, or as a software user interface. The personal audio player, which is likely processing the audio in a digital format, may control, or sequence, the lighting of the EL wire to match the music, for example, by simply varying the brightness of the EL wire with the volume of the audio signal, or pulsing the lighting with the beat of the music. Such active illumination with a sequencer will provide novelty and visual appeal for some music listeners.

The above example is just one of many possible applications of illuminated audio cabling. Other applications include variations of many elements of the above example. Elements that can be varied are: the number and type of audio signaling media, the number and type of illumination that runs along the cable, the power source for illumination, the location and type of driver circuitry, the location and type of sequencer (or lack thereof), the bonding or attachment mechanism between the audio signal medium and the illumination medium, and the location of switches or controls for the driver or sequencer (or lack thereof). While this list is not comprehensive, variations of all these elements are discussed below.

Virtually any audio cabling application may benefit from illumination. Other non-limiting example scenarios are provided here. An electric guitar can be connected to its amplifier via an illuminated audio cable. All instruments on stage at a musical performance may be wired with illuminated audio cabling, providing a distinct visual element to a live performance. Live performance cable lighting can provide visual indication of which instruments are performing at what time, and the color of the wire lighting can change with the mood of the music. Microphone wires can also be illuminated. In a home, standard box speakers used to fill room with music can be connected to an amplifier via illuminated audio cabling. Even wiring between consumer audio equipment, such as between a CD player and a switcher/amplifier can be illuminated, as can be wiring between other types of electronics equipment, including digital connections such as a USB, FIREWIRE, LIGHTNING or other type of cable between a computer and a peripheral device, monitor, etc. While illuminating a jumble of wires hidden behind a stack of home media consumer electronics boxes or personal computer components may not be a statement of personal style, it may be functional to help identifying which cables are which when rewiring the stack. In the same manner that audio data may be used to drive variations in the illumination of the cable, data being transferred through other types of cable may be used in a similar manner. Headphone cables other than the “Y” shaped earbud cable discussed above can also be illuminated. The audio source for illuminated headphones might include a home amplifier or any portable audio source, such as a portable music player or cellphone. Head-mounted speakers can be circumaural, supra-aural, earbuds, or ear canal speakers. Such illuminated cable headphones can also be integrated with a microphone for a phone headset.

The wires or medium for the audio signal in an illuminated audio cable can include any audio cabling mechanism. The most common may be multiple stranded electrically conductive wires, each wire electrically insulated from each other. However, any electrically conductive wires, including coaxial cabling, can be used, as can non-electrical cabling such as fiber optical cabling. Audio cables will usually include either one electrically conductive ground wire in a cable for all signal wires (all audio channels) in the cable, or may include a separate ground wire for each audio channel. The electrical insulated signal wires are often combined with uninsulated ground wires inside an exterior sleeve. Shielded cables may include the same insulated signal wires combined with ground wired inside the sleeve with the ground wires also being connected to an external metal sheath over the outside of the sleeve. Audio communication though the selected audio cabling may be analog or digital. Any variety of digital audio formats are possible, for example, AES/EBU, S/PDIF, ADAT, or TDIF. The cable itself may be very flexible as most earbud wiring is with stranded wires, or less flexible, as coaxial cabling is with its solid metal core inside a solid insulator. The geometry of the wire may be a simple point-to-point layout, or may it have branches such as the typical “Y” configuration for earbuds, where the wires from each ear join together somewhere midway between the ear speakers and the single plug for the audio source. The number of audio conduits can vary by application. For example, a single signal wire plus a ground wire can provide single channel (mono) audio, or two signal wires plus a ground wire can provide two channel (stereo) audio. Additional signal wires can provide additional audio channels, including bi-directional audio signals.

The light emitted from an illuminated audio cable can originate from a variety of materials, any of which, when configured in a long, thin form, flat or not, will be referred to herein as a light strip. Electroluminescent wire, or EL wire, with a phosphorus layer between a copper core and a thin outer wire is one such source that can be very power efficient and flexible. Another option similar in operating principal to EL wire is electroluminescent tape (EL tape), constructed, for example, with phosphorus sandwiched between a flat rear electrode and a transparent flat front electrode, and with a transparent moisture barrier top cover. EL wire and EL tape can produce different colors by varying the phosphor used and/or by coloring an outer translucent layer with dyes. An LED (light emitting diode) light strip can also be used, where a series of small LEDs are strung together and typically encased in a transparent flexible sleeve. LEDs can be different colors, and combining multiple alternating colors in a single strip allows for a large variation of light color produced by varying the intensity of each of the perhaps 2, 3 or 4 alternating colors individually in the single strip. Another light source option is a fiber optic side glow cable, comprised of one or more strands of fiber optic material, where light from a light source at one end of a fiber optic strand produces a uniform glow from the entire length of cable. The fiber optic cable acts as a light pipe, efficiently transmitting light from the light source through the entire bending length of the cable, and diffraction throughout the length of the cable produces a fairly uniform light emission. The light source can be any single or variable color light, producing any single or variable color glow for the length of the fiber optic cable. This list is not exhaustive, as any type of long, thin, and (for most applications) flexible light source and be combined with an audio signal transmission medium to create an illuminated audio cable.

In the above embodiment, the side emitting fiber may also be the audio conduit such that no additional audio conduit is required. While audio and other data signals are typically transmitted at a set frequency, this does not have to be the case, so the optical signals transmitted through the fiber could be at different wavelengths and therefore have different colors. A coder on the transmission side, such as within a driver, may be programmed to determine the frequency of the transmission, i.e., light color, and a decoder on the receiver side may be programmed to receive the data in the transmission and convert that data to a form suitable for use on the receiver side. As a result, the color of the fiber conduit may be changed from time to as desired while still carrying the audio or other data as needed.

The elements of a driver for a light strip depend on the type of light strip. For example, a driver for an LED light strip must produce the electric power appropriate for powering a string of LEDs. A driver for a side glow fiber optic cable includes a light source and electronics to power the light source. Drivers for EL wire and EL tape must produce a high voltage alternating current as described above.

Branched audio cables, such as the “Y” cable for some headphones, can be paired with any of the above light sources. However, most of the above light sources are not easily split or merged at a branch. An obvious option for addressing this includes lighting only one branch, for example, in the case of headphones, only lighting the segment of cable from the personal audio player up to the “Y” branch point, and not lighting the branches that continue up to each ear. One option includes a double loop, where, for example a light strip may start at the audio source plug, go up to the “Y” intersection, continue on a first branch to the end and loop back to the intersection, continue out on the second branch to loop back to the intersection, and finally continue back to the plug. Such a loop will have two strips of the light on each branch of a branched cable using only a single light strip. Another option provides separate right-left lighting control on a “Y” shaped headphone cable by using two light strips, both originating at the audio source plug, going up to the intersection, where only one light strip continues up each of the separate right and left cables to the ears. In this arrangement, brightness or color can be separately controlled on the right and left branches.

Many methods are available for attaching the audio signal medium to a light emitting strip. The two separate elements can simply be glued or taped together along the length of the illuminated audio cable. The insulated exterior of an audio wire is often molded plastic of some sort, and this molded exterior could be molded simultaneously around whatever type of light emitting strip is desired, as long as the plastic molded around the light strip is translucent to allow light emissions. The audio medium can also be insulated separately from the light strip used, and then both light strip and insulated audio conduit can be combined together in a translucent or transparent sleeve. If the light strip is sufficiently thin in one dimension, such as with electroluminescent tape, it can be wrapped around the audio conduit, for example in a spiral. An alternate design for electroluminescent tape, described further below, includes separating the right and left audio wires, and attaching them to on either edge of electroluminescent tape—the right audio channel running on one edge of the tape, and the left channel running along the other edge.

Any portion of an audio cable can be illuminated, but many will have substantially the whole length illuminated. The term “substantially” can be defined by way of example: A “Y” shaped headphone wire is illuminated substantially along its entire length when the illuminating element originates from close to the audio source plug, continues up to the “Y” intersection, and continues along the branches to both ears until a point close to where the right and left cables attach to the right and left speaker enclosures. It is possible for the illumination to continue right into the audio output and source enclosures. However, in some applications an ancillary light strip component (such as the driver, power source, switches/controls, or a separate light source for the light strip) can be a physically separate component from the audio elements (separate from the cable, audio source, and speakers), and hence the audio transmission medium and the light strip may need to diverge at some point, possibly close to one or more ends of the illuminated audio cable.

A driver containing electronics necessary to drive the light strip will usually be necessary. In the case of EL wire or electroluminescent tape, the current from a power source will usually need to be converted to the necessary voltage, amperage, and/or frequency. The location of the driver electronics is flexible and can be located, for example: inside the audio source, inside the audio output device (e.g., speakers), incorporated into the cabling itself in a thin enclosure somewhere between the ends of the cable, incorporated into a plug at one end of the cable, or in a box or enclosure of some sort separate from all other components. The driver electronics may also be built into the audio device itself, such as an MP3 player, a smart phone, etc. On/off switches or other controls (hardware or software based) can be incorporated into the driver circuitry and in the physical housing of the driver, or controls or switches can be wired to a more convenient remote location, for example, in the right earbud wire of a headset along with the microphone, so that switches and microphone hang just below a wearer's jaw.

A power source is usually necessary for a light strip. Any power source can be included with appropriate driver electronics. Options for power sources may include a wall outlet, the power from an audio source (such as the low voltage DC current produced by a power supply inside a many non-mobile electronics devices), or a separate battery intended only for the light strip. The battery powering a mobile audio source can also power the light strip. Possibly locations for a battery powering only the light strip can mirror options for the driver electronics above, i.e., inside the audio source, inside the audio output device (e.g., speakers), incorporated into the cabling itself in a thin enclosure somewhere between the ends of the cable, incorporated into a plug at one end of the cable, or can be in a separate box or enclosure of some sort separate from all other components. A battery can be incorporated into the driver electronics, or positioned elsewhere.

A sequencer can optionally control a light strip beyond a simple on/off switch. For example, the brightness or color of the light strip can be tied to: the instantaneous audio volume measurement, the energy in certain frequency components of the audio, or a beat detection mechanism. In the case of an LED light strip or other light strips with multiple separate illumination sources, a sequencer can provide the timing for when individual LEDs or groups or patterns of LEDs light up, in addition to the brightness and color of the individual LEDs or groups or patterns of LEDs. A sequencer may separately control the lighting of the right and left wires for right and left speakers, where the control of the right wire lighting is related to the right audio channel content, and the left wire lighting is related to the left audio channel content. A sequencer may be stand-alone electronics, or may be a software component running on a computer, for example, the computer inside a portable digital audio player or smart phone.

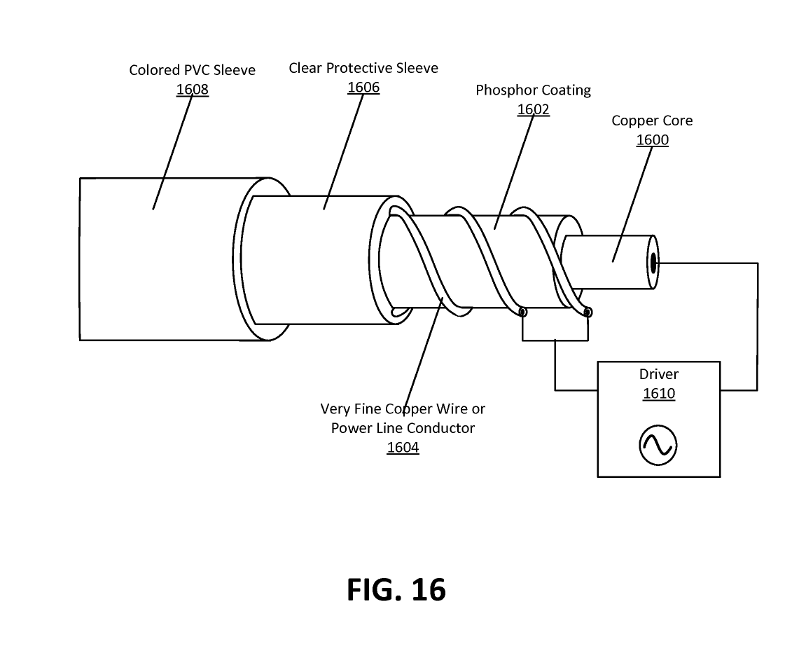

FIG. 16 depicts components of a cable containing an electroluminescent wire (EL wire). As illustrated, phosphor coating 1602 surrounds a copper core 1600, and very fine copper wire 1604, which may be two or more parallel strands, wraps around the phosphor coating 1602. A protective sleeve usually surrounds this, and as depicted here there are two sleeves: a clear protective sleeve 1606 and a colored PVC (polyvinyl chloride) sleeve 1608. The numbers of colors that can be produced by excited phosphor are limited, and the color in the colored PVC sleeve 1608 allows for more variation. A driver 1610 provides the voltage and AC frequency necessary to excite the phosphor and cause it to glow.

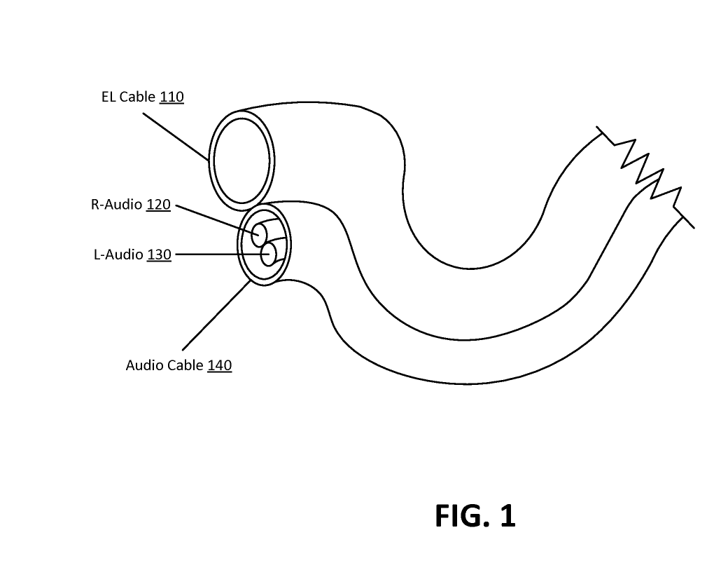

An illustration of a few non-limiting embodiments of an illuminated cable in accordance with the present disclosure are depicted in FIGS. 1-8. FIG. 1 illustrates an EL wire side-by-side with an audio conduit. In FIG. 1, two self-contained cables, the EL cable 110 and the audio cable 140, are attached along their exteriors throughout the length of the cables to create a single illuminated audio cable. The EL cable 110 is an EL wire contained in a protective sleeve. The EL wire in this case may be any light strip including the EL wire described above or with FIG. 16. The audio cable 140 includes an R-audio 120 (right-channel audio) signal medium and an L-audio 130 (left-channel audio) signal medium. A protective sleeve also encloses the R-audio 120 and L-audio 130 media. The signal conduit may, for example, be an insulated stranded wire with a ground, as described above, but could be any conduit capable of carrying an audio signal. The number of conduit, depicted here as two, can vary, as can the intended use of each audio channel. For example, there may be just one conduit for a single (mono) audio channel. Or, for a stereo headset, there may be 3 conduits, for two speakers signaling in one direction and one microphone input in the opposite direction. The attachment between the EL cable 110 and the audio cable 140 can by any mechanism that allows the two constituent cables to act as a single cable. Non-limiting examples for attachment may include: gluing the protective sleeves together, melting the protective sleeves together, forming the protective sleeves jointly in a single molding process, or taping the two sleeves together.

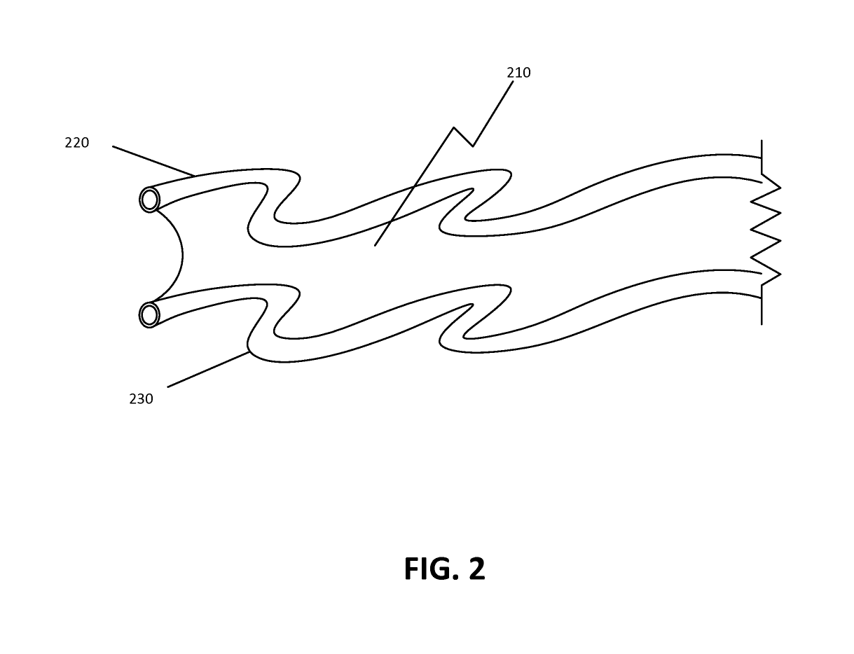

FIG. 2 is an illustration of EL tape between two audio wires 220 and 230. As depicted in FIG. 2, EL tape 210 provides the structure holding audio wires 220 and 230 together as a single cable. Audio wire 220 and audio wire 230 may include any audio signal conduit, as discussed with FIG. 1 above. Each audio wire 220 and 230 may be completely self-contained with a ground wire in each, or they may have a shared ground wire. EL tape 210 is any light strip configured as a long, flat tape. It may be configured to illuminate on either side or may only illuminate on one side. The attachment mechanism between EL tape 210 and each audio wire 220 and 230 can include any mechanism that allows the entire assembly to operate as a single cable, just as with the configuration in FIG. 1. This may include an adhesive, or melting the outer protective sleeves together, or even molding the protective layer of both wires and the EL tape as a single combined layer all at once.

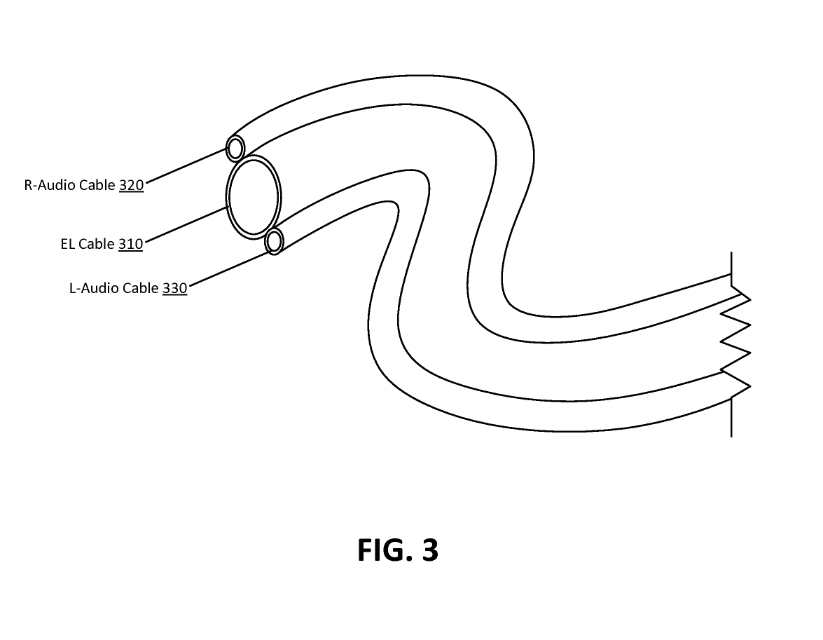

FIG. 3 is an illustration of EL wire positioned between audio wires, and may be considered a combination of the embodiments depicted in FIGS. 1 and 2. Here, EL cable 310 provides the structure holding R-audio cable 320 and L-audio cable 330 together. Each of the cables 310, 320, 330 may be completely self-contained cables, simply attached lengthwise. Or, components could be shared, for example, sharing a single ground wire. Again R-audio cable 320 and L-audio cable 330 may comprise any conduit capable of carrying an audio signal, and EL cable 310 maybe any light strip. As discussed earlier, the attachment mechanism may be a mechanism allowing the combined result to act as a single cable.

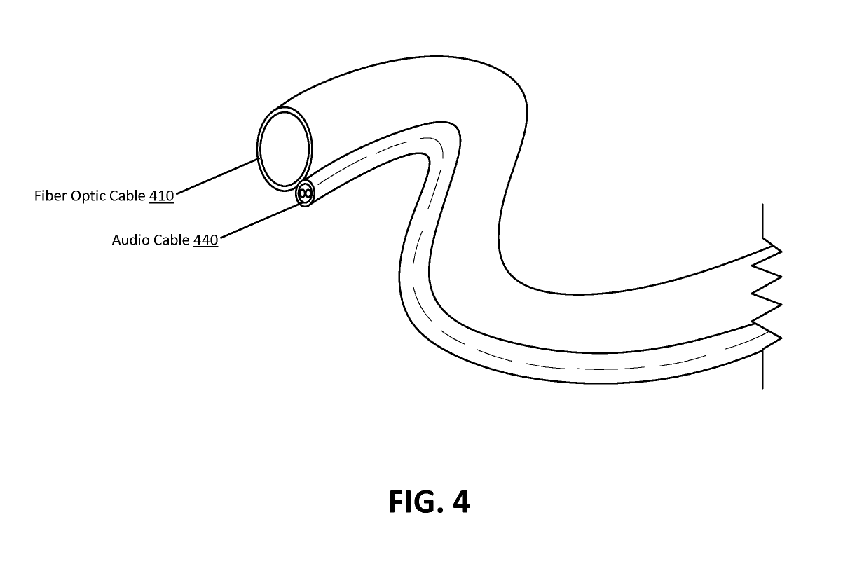

FIG. 4 is an illustration of fiber optic cable combined with an audio cable. Similar to FIG. 1, possibly self-contained fiber optic cable 410 is attached to self-contained audio cable 440. Audio cable 440 may, of course, enable transmission of one or more audio signals, but as suggested by FIG. 4, there may be 2 signals transmitted over two separate stranded wires which are separately encased in their own cavity of a single molded insulating and protective sheath. Any attachment mechanism can be used to join fiber optic cable 410 and audio cable 440, as discussed above.

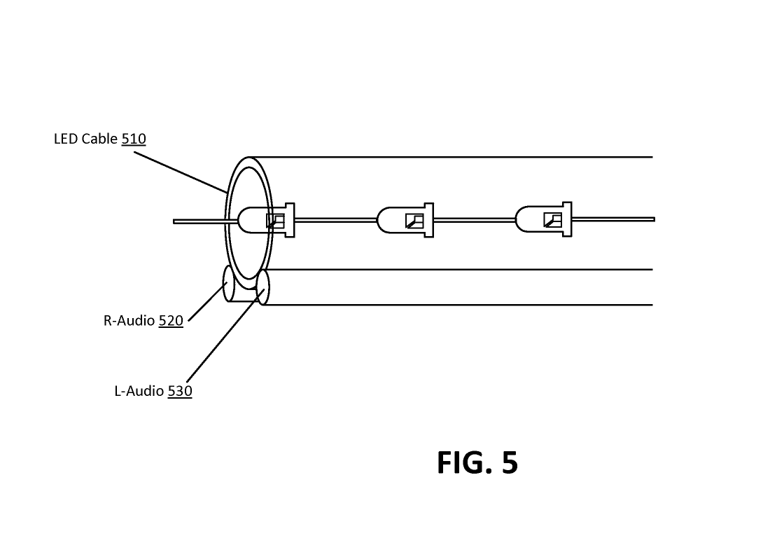

FIG. 5 shows another variation on attaching a separate light strip and audio cables. In FIG. 5, an LED chain cable 510 is combined with multiple audio cables 520 and 530. LED cable 510 could be any light strip, but is depicted as a chain of LEDs in a translucent sleeve of some sort. R-audio 510 and L-audio 530 are separately attached to LED cable 530. R-audio 520 and L audio 530 are separate cables and separately attached to the larger Light strip cable as in FIGS. 2 and 3, but as opposed to FIGS. 2 and 3, both audio cables are on the same side of the light strip. There could, of course, be additional (more than 2) separately attached audio cables. The audio cables can consist of any audio-signal-carrying conduit.

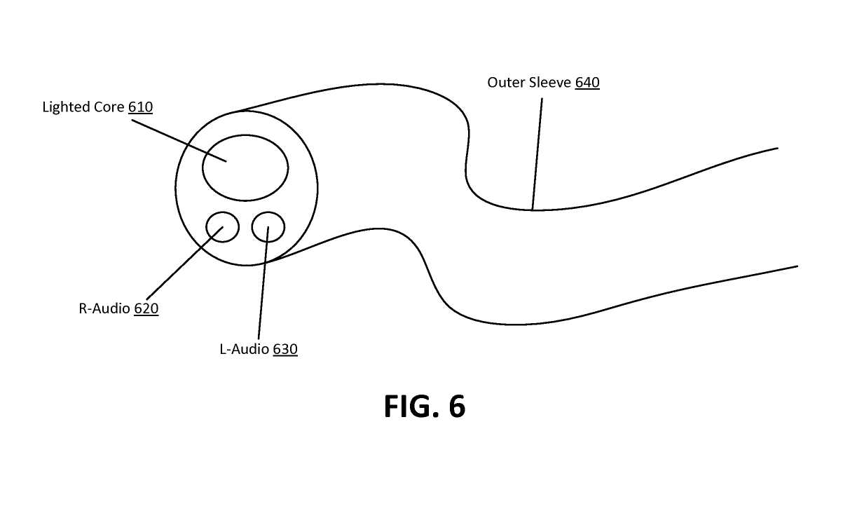

FIG. 6 depicts audio wiring 620 and 630 and illumination core 610 directly inserted into a light strip cable. As illustrated, the lighted core 610, R-audio 620 and L-audio 630 are all inside a single outer sleeve 640. The lighted core 610 can again be any light strip included in a single sleeve with the audio, but as the term “lighted core” suggests, it need not be a freestanding cable since it will have a protective sleeve surrounding it. For example, if the lighted core 610 was an EL wire as depicted in FIG. 16, one or possibly both sleeves need not be included in the lighted core 610. The clear protected sleeve 1606 of FIG. 16 may need to be included in the lighted core as an air barrier to the phosphor coating 1602. However, the colored PVC sleeve 1608 which, in part, determines the color of the EL wire light strip in FIG. 16, need not be included in the lighted core 610, as the exterior sleeve of the entire assembly in FIG. 6 can be translucent and colored to provide the same function.

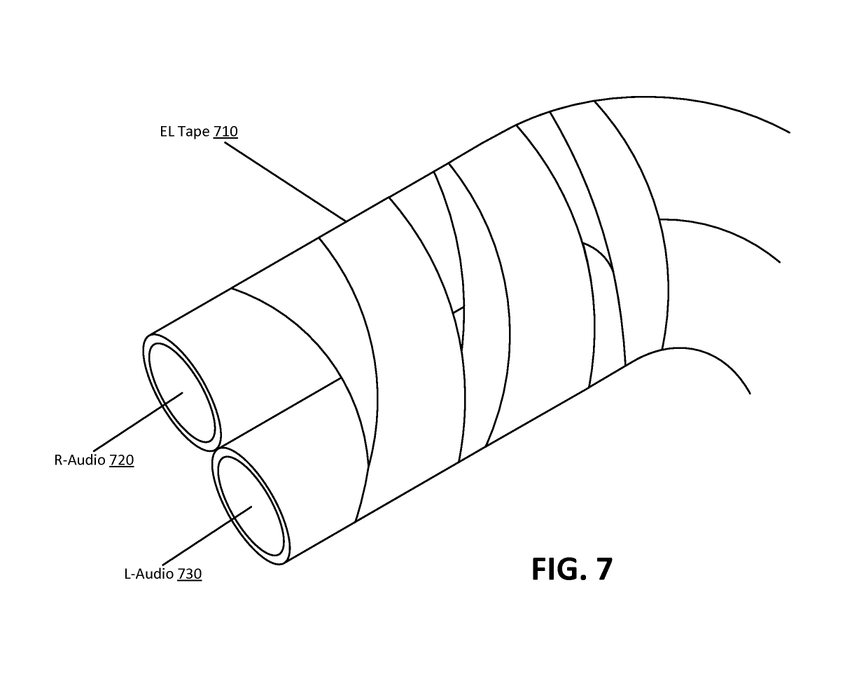

FIG. 7 is an illustration of an EL tape wrapped audio cable pair. R-audio 720 and L-audio 730 again can be independent freestanding cables of any audio signal conduit, and are likely insulated before the EL tape is wrapped. EL tape 710 wraps around the audio cables R-audio 720 and L-audio 730 here. EL tape 710 can be any light strip that can be wrapped around the audio cables, and is depicted as being the flatter EL tape described above. EL tape 710 may or may not be held in place by an adhesive or other means. The R-audio 720 and L-audio 730 may be held together only by EL tape 710 which may allow the audio cables to slide alongside each other as the overall cable bends, or the audio cables may be separately attached to each other via adhesive or other means. The wrap of EL tape 710 may be dense and overlapped as depicted here, or it may be a loose spiral with gaps between the lines of tape laid with each circumference of the spiral around the audio wires. The number of audio cables inside the wrapped EL tape 710 can also vary.

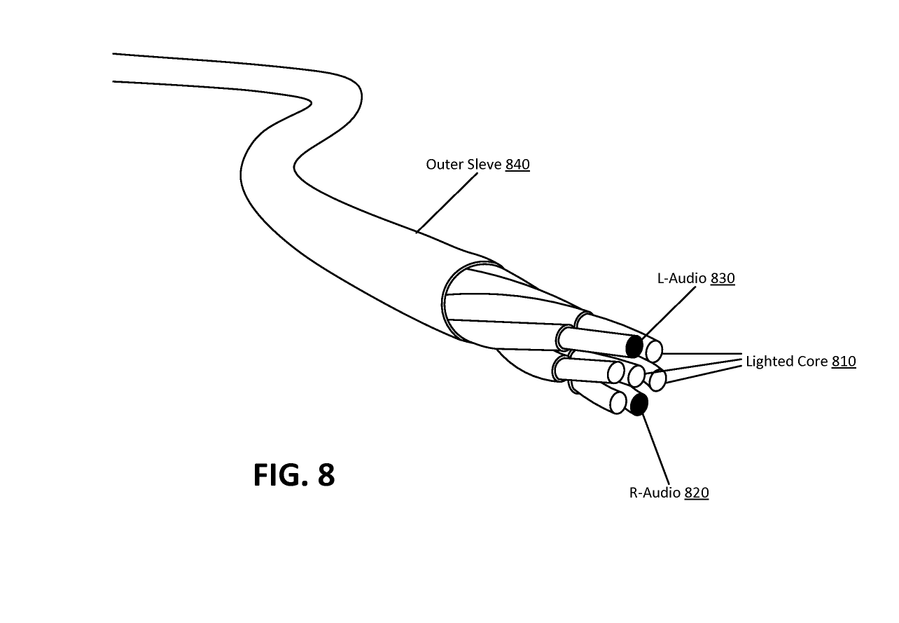

FIG. 8 depicts an illustration of audio inserted in a bundle of multiple lighted core elements. As depicted, two audio channels, L-audio 830 and R-audio 820 are included with 5 lighted cores 810 spiraling inside an outer sleeve, though the interior elements or strands may or may not be spiraling together. The individual interior strands may not be attached to each other and may be held in place only by the outer sleeve 840, although the individual elements are likely individually insulated and protected from abrasion as the cables flexes using some type of individually wrapped protective layer. Each lighted core 810 again can be any type of light strip, but may be fiber optic or side glow strands. The audio strands L-audio 830 and R-audio 820 can contain any audio signal conduit, including fiber optic strands. The number of audio strands and the number of light strip strands is variable. Multiple lighted strands allows for individual strands of different colors, and by varying the intensity or brightness of different colors individually allows for production of a composite color with very wide variety.

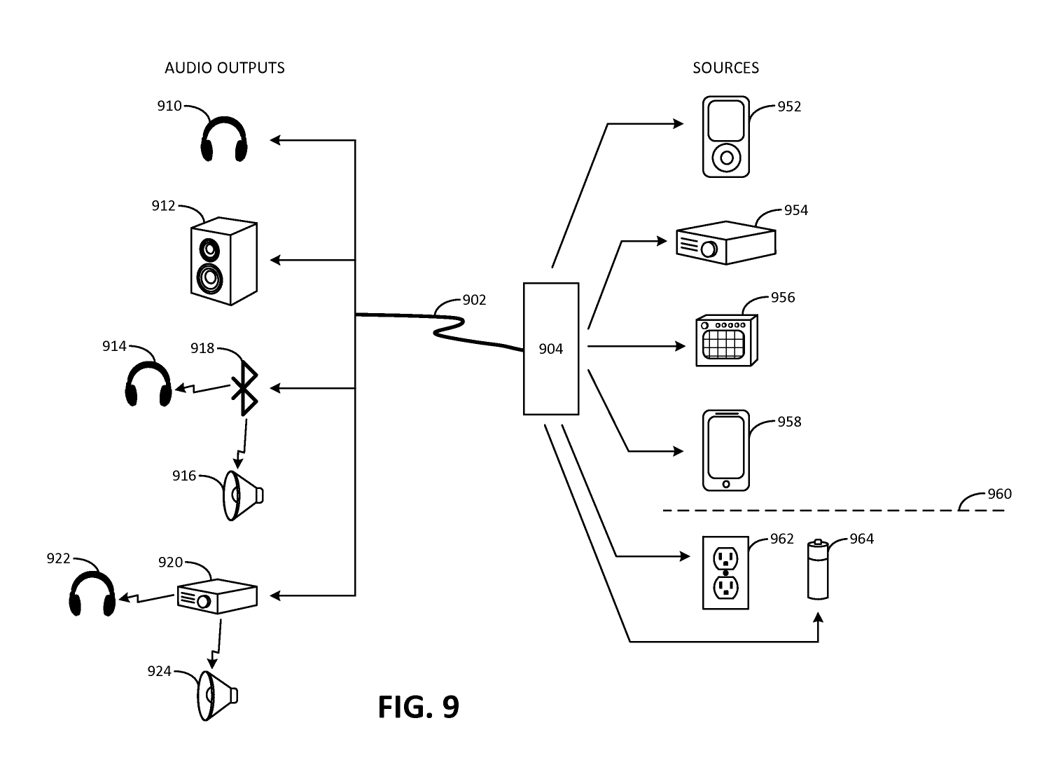

Changing topic from the cable structures of FIGS. 1-8 above, FIG. 9 depicts an overview of some applications for illuminated audio cabling. Illuminated audio cable 902 runs between sources of audio and power on the right and audio outputs on the left. The cable 902 can be any light strip cable. Audio outputs may include direct connection to headphones 910 or box speakers 912, may be connected to a BLUETOOTH or other type of wireless transmitter 918 which then transmits wirelessly to headphones 914 or other speaker 916, may be connected to amplifier/switcher 920 which is then connected to headphones 922 or other speaker 924, or may be connected to any other type of audio signal consumer not depicted. Driver 904 accepts both an audio signal and power as input from the sources on the right. Below line 960 are power only sources including wall power 962 and battery power 964. Above line 960 are devices that can provide audio and may also provide power, such as smartphone 958, guitar amplifier 956, home audio system amplifier 954, personal music player 952 or some other type of device using other data/power connector, such as a USB connecter, FIREWIRE, LIGHTNING etc. Of course any audio source can provide the audio input to driver 904 and illuminated audio cable 902, including sources not depicted here, such as: professional audio mixing or editing equipment, personal tablet device, personal computer, or direct or indirect connection to musical instruments. The driver and/or power source, while not depicted here, may be on the output end of the illuminated audio cable 902. In general, many combinations of audio source, audio output, power source, and driver location are feasible.

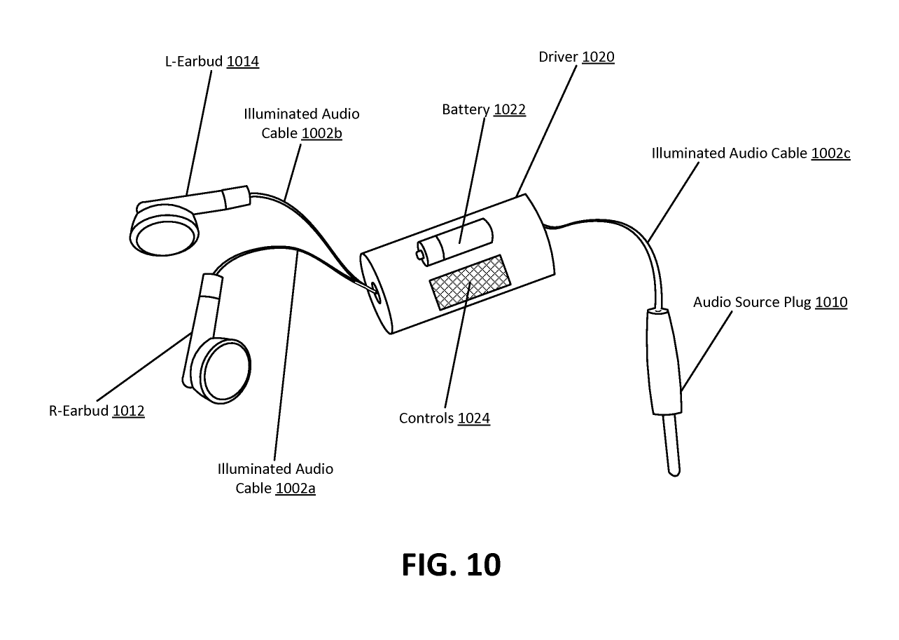

FIGS. 10-14 depict more details of specific applications of illuminated audio cabling. To begin, FIG. 10 illustrates earbud headphones with illuminated audio cabling and a cable mounted driver. The speakers L-earbud 1014 and R-earbud 1012 are connected to driver 1020 via illuminated audio cables 1002b and 1002a. The driver is then connected to audio source plug 1010 via illuminated audio cable 1002c. The earbuds 1014 and 1012 can easily be any headphone speaker type. The audio source plug 1010 can be any standard single- or multi-channel audio signal plug or jack. The illuminated audio cables 1002 can be any combination of light strip and audio signal conduit discussed above. The drive 1020, located somewhere along the illuminated audio cable itself, contains a battery 1022 power source and controls 1024 for the internal electronics that transform the battery power into what is needed to drive the light strips in the illuminated audio cable. Example internal electronics include conversion of low-voltage DC power to high-voltage AC to power EL wire or EL tape; conversion to power an LED chain; or conversion for powering a light source for fiber optic where the light source may also be included inside driver 1020. The controls may be buttons, switches or dials to control the lighting. Example controls may include on/off, brightness, color controls. If a sequencer is incorporated into the driver 1020, then additional controls for speed, pattern, or any other sequencer control might also be included in the driver 1020. Note the cylindrical shape of driver 1020 is purely conceptual, and any shape, perhaps a more ergonomic shape, can be used that will contain the necessary electronics.

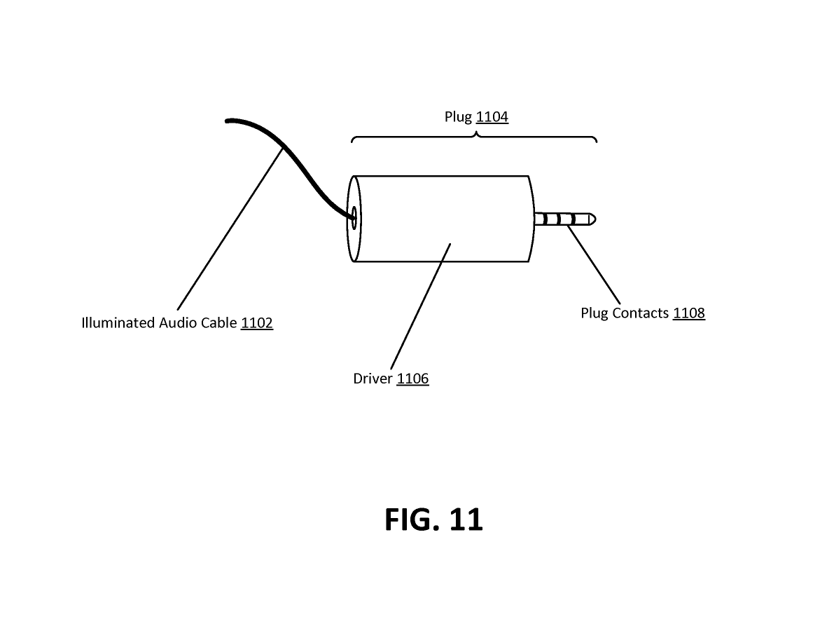

FIG. 11 depicts the driver incorporated into the handle of an audio plug. The illuminated audio cable 1102 terminates into the plug 1104 which includes the plug contacts 1108 and a plug handle which is the driver 1106. Note again the cylindrical shape of the driver 1106 is purely conceptual, and any physical shape that hold the desired electronics will suffice. The illuminated audio cable 1102 can be any light strip described above, and the driver 1106 should contain electronic appropriate to the light strip used in the illuminated audio cable 1102. Just as in FIG. 10, and although not depicted, driver 1106 may contain a batter power source and controls for the driver electronics. Driver 1106 may also include a sequencer. Plug contacts 1108 may be any standard or custom audio jack for audio input, output, or both. In addition to allowing connection to an audio source or output, plug contacts 1108 may also allow for connect to a power source, eliminating the need for battery power to be housed inside the driver 1106.

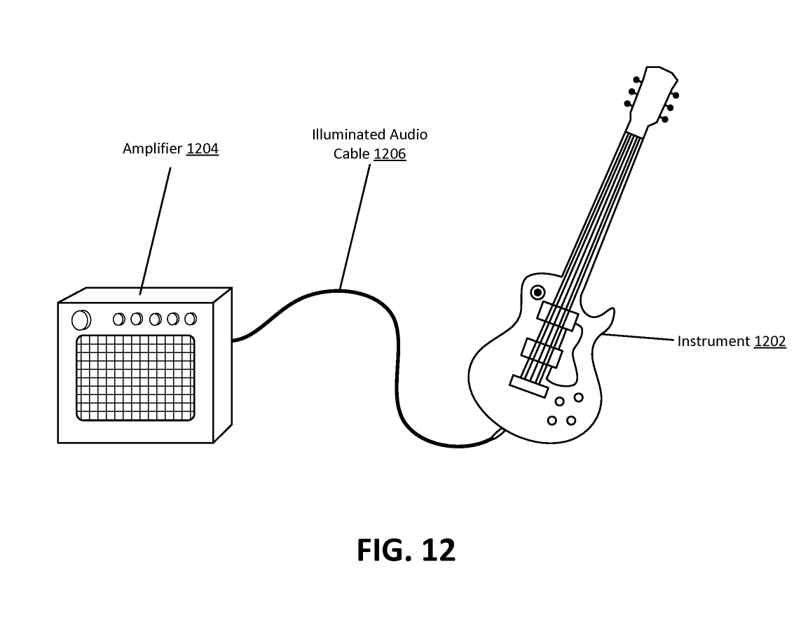

FIG. 12 depicts an illuminated audio cable application in live music performance. Instrument 1202 is an audio source which is attached to amplifier 1204 via illuminated audio cable 1206. The depicted instrument 1202 is a guitar, but any electrified instrument producing an audio signal could be used, and any type of light strip can be included in the illuminated audio cable. Driver electronics are not depicted, but could be incorporated in either the instrument 1202, or amplifier 1204, or could be separate driver box that sits, for example, on or near the amplifier 1204 and plugs into wall power as a power source. Controls for the driver could be anywhere, but in a live music performance controls may be centralized for all instruments in the same location that audio volume levels are adjusted. Alternatively, controls may be incorporated somewhere near the instrument for the performer to control directly, for example into the plug at the source end of the illuminated audio cable.

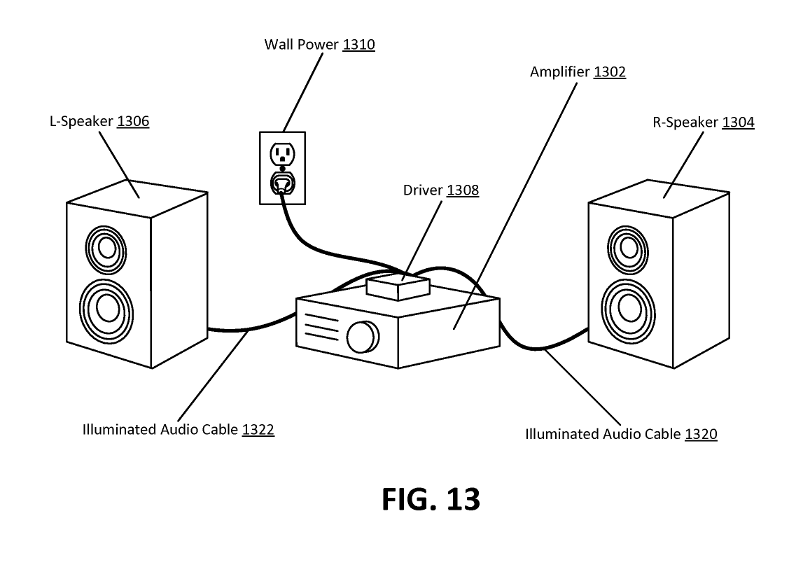

FIG. 13 depicts a standard home stereo system with illuminated audio cable. Music source and amplifier 1302 sends audio for output to L-speaker 1306 via illuminate audio cable 1322, and to R-speaker 1304 via illuminated audio cable 1320. As depicted here, driver 1308 for the light strips in the illuminated audio cables is a separate box located near the amplifier 1302, and is powered by wall power 1310.

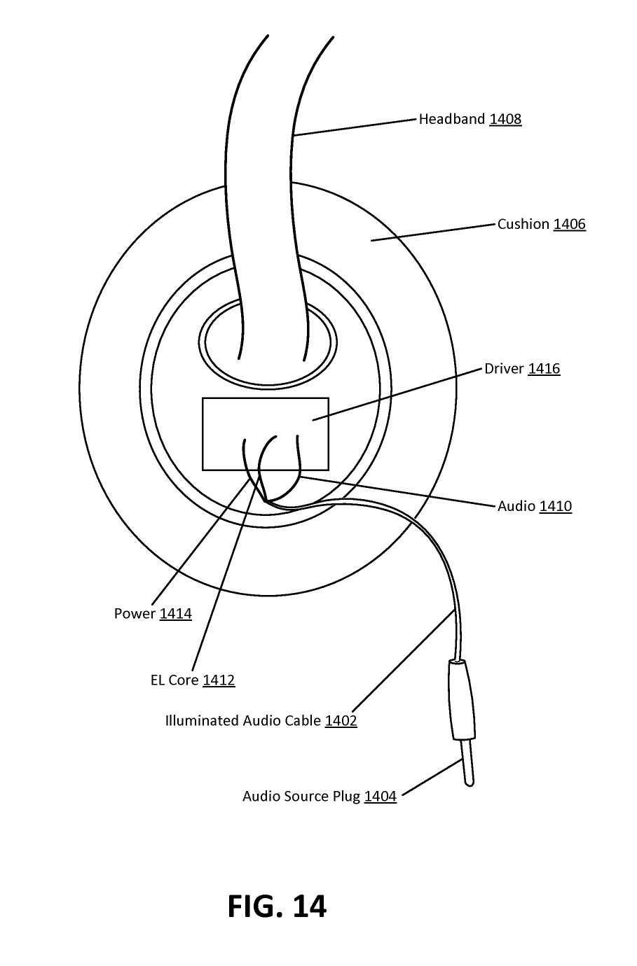

A final application of an illuminated audio cable is depicted in FIG. 14, which shows a circumaural headphone with the driver integrated into the head mounted components. An audio source plug 1404 may be connected by illuminated audio cable 1402 to the head mounted circumaural headphones. The illuminated audio cable 1402 may include separate components that connect into the driver, including power 1414, EL core 1412, and audio 1410. These components could be combined and are shown separately primarily for illustrative purposes: Again, the audio 1410 may include any medium capable of carrying an audio signal; and the EL core may include any type of light strip. Driver 1416 converts the power 1414 source to what is necessary to drive the EL core, or alternatively the power source may be a battery inside the head mounted device. Headband 1408 wraps around the head to hold the cushion 1406 over the wear's ear. A speaker on the opposite side of the headphone in FIG. 14 is not depicted, but may be a mirror image of the speaker illustrated in FIG. 14, or a simple speaker that is connected to the speaker illustrated in FIG. 14 by a wire (not shown) passing through the headband 1408.

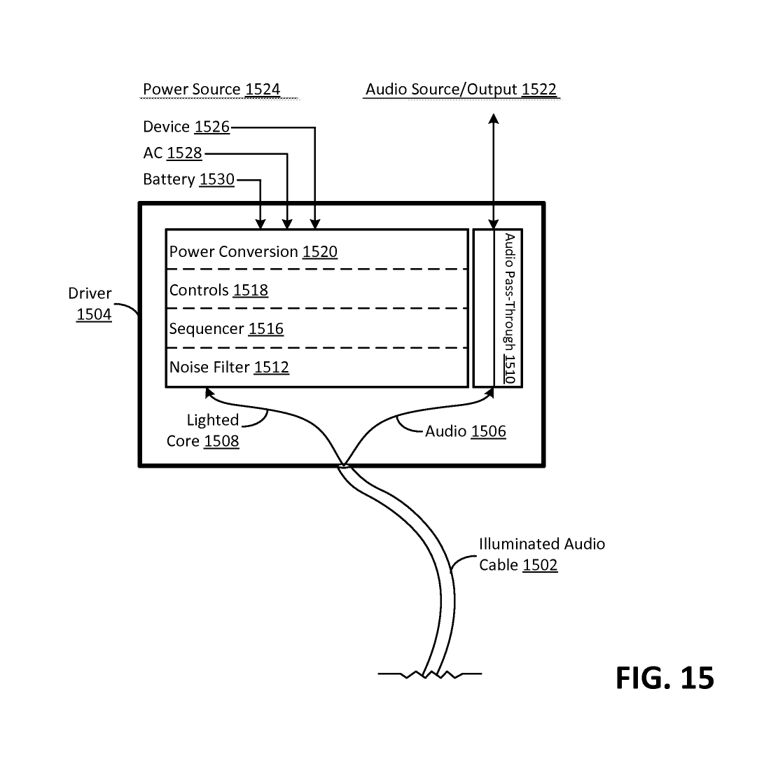

FIG. 15 depicts some functional components of a driver for an illuminated audio cable. The illuminated audio cable 1502, depicted as connected to the bottom of the driver 1504, includes both a lighted core 1508 and audio 1506 components. The audio 1506 component is simply connected to the audio pass through 1510, which, on the other side of driver 1504 is connected to the audio source/output 1522. The audio signal here may be one or more single or bi-directional audio channels. On the lighted core side of the driver 1504 (the left side), a power source 1524, which may come from a device 1526, a AC power source 1528, or a battery 1530, is input to the top of the functional blocks inside the driver. The first element depicted is the power conversion 1520, which produces the power attributes to what is necessary to illuminate whatever type of illumination element is in lighted core 1508. The controls 1518 may include an on/off switch for the illumination and an optional coder/decoder as appropriate. An optional sequencer 1516 can provide additional illumination effects, processing and control, and finally an optional noise filter 1512 is depicted. The block depicted here may be rearranged in other orders, and most are optional and may not exist in certain embodiments.

FIG. 16 depicts an ordinary cable containing an EL wire. Embodiments may use a similarly constructed wire to additionally transport an audio signal. In one such embodiment, the signal may be transmitted over the copper core 1600, in addition to the AC signal transmitted through the wire 1604 necessary to excite phosphor coating 1602. In another embodiment, an additional digital signal can be transmitted over wire 1604 as a power line conductor using power line networking (PLN) technologies. Such a digital signal can include one or more audio signal channels. Typically, in these PLN technologies, a carrier signal different from the existing power AC frequency single is used to carry the additional digital signal. To apply PLN to an EL wire, the digital carrier signal would be different from the AC frequency used to excite the phosphor. Such a method can be applied to other types of light strips as well, such as EL tape. An advantage of such an embodiment is improved visual effect. By eliminating the separate audio signal conduit, any visual effect of the audio conduit blocking the illumination is eliminated.

While this document contains many specifics, these should not be construed as limitations on the scope of an invention or of what may be claimed, but rather as descriptions of features specific to particular embodiments of the invention. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be exercised from the combination, and the claimed combination may be directed to a subcombination or a variation of a subcombination.

1. An illuminated audio cable, comprising:
a signal conduit capable of carrying at least one audio signal; and
at least one strip of light emitting material connected to the signal conduit along a length of the signal conduit.

2. The illuminated audio cable of claim 1, wherein the signal conduit carries an audio output and is connected to headphones.

3. The illuminated audio cable of claim 1, wherein signal conduit carries an audio input is configured to enable connection to a musical instrument.

4. The illuminated audio cable of claim 1, wherein the at least one strip of light emitting material includes one or more of an electroluminescent wire, an electroluminescent tape, side glow fiber optic strands, and a string of LEDs (light emitting diodes), and phosphorus.

5. The illuminated audio cable of claim 1, wherein:
the at least one strip of light emitting material is electroluminescent tape with a first edge and a second edge, wherein the first edge is along a length of the tape and the second edge along the length of the tape and opposite the first edge;
the signal conduit comprises a first wire and a second wire;
the first wire is connected to the first edge; and
the second wire is connected to the second edge.

6. The illuminated audio cable of claim 1, wherein the at least one strip of light emitting material is attached to driver electronics, and the driver electronics are integrated into one or more of an audio source, an audio destination, the signal conduit, and a plug at an end of the signal conduit.

7. The illuminated audio cable of claim 6, wherein the driver electronics are connected to at least one control, the control is physically separate from the driver, and the location of the at least one control includes one or more of integrated into the audio source, integrated into the audio destination, integrated into the signal conduit, and integrated into the plug at the end of the signal conduit.

8. The illuminated audio cable of claim 1, wherein a power source for the at least one strip of light emitting material includes one or more of a standard wall power plug, audio source electronics, audio destination electronics, and a battery.

9. The illuminated audio cable of claim 1, further comprising:
a driver, wherein the driver is configured to produce electric power that causes the at least one strip of light emitting material to emit light; and wherein:
the signal conduit is attached to the at least one strip of light emitting material along a length of the at least one strip of light emitting material for substantially an entire length of the at least one strip of light emitting material.

10. The illuminated audio cable of claim 9, wherein the signal conduit carries an audio output and is connected to headphones.

11. The illuminated audio cable of claim 9, wherein the signal conduit carries an audio input and is configured to enable connection to a musical instrument.

12. The illuminated audio cable of claim 9, wherein the at least one strip of light emitting material comprises one or more of an electroluminescent wire, an electroluminescent tape, side glow fiber optic strands, a string of LEDs (light emitting diodes), and phosphorus.

13. The illuminated audio cable of claim 9, wherein:
the at least one strip of light emitting material is electroluminescent tape with a first edge and a second edge, wherein the first edge is along a length of the tape and the second edge along the length of the tape and opposite the first edge;
the signal conduit comprises a first wire and a second wire;
the first wire is connected to the first edge; and
the second wire is connected to the second edge.

14. The illuminated audio cable of claim 9, wherein the driver location is one or more of integrated into an audio source for the signal conduit, integrated into an audio destination for the signal conduit, integrated into the signal conduit, and integrated into a plug at an end of the signal conduit.

15. The illuminated audio cable of claim 9, wherein a power source for the at least one strip of light emitting material includes one or more of a standard wall power plug, electronics of an audio source of the signal conduit, electronics of an audio destination of the signal conduit, and a battery.

16. The illuminated audio cable of claim 9, further comprising a controller controlling the driver, wherein the controller is located in one or more of integrated into an audio source, integrated into an audio destination, integrated into the signal conduit, and integrated into a plug at an end of the signal conduit.

17. A headphone system, comprising:
two speakers, where the speakers are configured to be placed on a head of a user;
at least two audio signal wires, wherein the output of the audio signal wires are each connected to one of the two speakers;
at least one electroluminescent wire attached to a length of the audio signal wires to create an audio cable; and
a driver for the electroluminescent wire, where the driver is powered by a mobile battery source.

18. The headphone system of claim 17, wherein the driver or a controller for the driver is located on the audio cable.

19. The headphone system of claim 17, wherein an input to the at least two audio signal wires comes from a mobile personal audio device, and the driver or a controller for the driver is integrated into the mobile personal audio device.

20. The headphone system of claim 17, wherein the driver or a controller for the driver is integrated into the speakers or a support for the speakers.
